(19) United States
(12) Patent Application Publication
(10) Pub. No.: US 2025/0265965 A1
(43) Pub. Date: Aug. 21, 2025

(54) TIMING CONTROLLER, DISPLAY DEVICE AND SYSTEM INCLUDING THE SAME

(71) Applicant: SAMSUNG ELECTRONICS CO., LTD., Suwon-si (KR)

(72) Inventors: JAEWON CHOI, Suwon-si (KR); Sooyoung Woo, Suwon-si (KR); Sang-Hoon LIM, Suwon-si (KR); Kyung-Sang CHO, Suwon-si (KR); Myoungsik Yun, Suwon-si (KR)

(73) Assignee: SAMSUNG ELECTRONICS CO., LTD., Suwon-si (KR)

(21) Appl. No.: 18/921,812

(22) Filed: Oct. 21, 2024

(30) Foreign Application Priority Data
Feb. 15, 2024 (KR) 10-2024-0022081

(51) Int. Cl. G09G 3/20

(52) U.S. Cl. CPC G09G 3/2096; G09G 2330/021

(57) ABSTRACT

A timing controller is provided. The timing controller includes: a plurality of registers located in a power gating region and configured to store a plurality of setting values; an image processing circuit configured to receive an image signal and perform image processing on the image signal based on the plurality of setting values; a restore memory located outside the power gating region and configured to store the plurality of setting values; and a bus controller configured to receive the plurality of setting values and store the plurality of setting values in the plurality of registers and the restore memory.

### CROSS-REFERENCE TO RELATED APPLICATION

This application claims priority to Korean Patent Application No. 10-2024-0022081, filed in the Korean Intellectual Property Office on Feb. 15, 2024, the disclosure of which is incorporated by reference herein in its entirety.

### BACKGROUND

### 1. Field

The present disclosure relates to a timing controller, a display device and system including the same.

### 2. Description of Related Art

A display panel displays images and provides various visual information to users. The display panel includes a plurality of pixels, and each of the plurality of pixels expresses light of a certain luminance to display an image. A display driver may include a Display Driver Integrated Circuit (DDI) to process image signals and drive pixels.

Power gating, in which may be used to reduce the power consumption of the DDI by between a power-down state and a power-up state. The DDI may store setting values for processing video signals in registers, which may be lost when the DDI is in the power-down state. To prevent setting values from being lost, there is a need for a method to maintain setting values stored in registers.

### SUMMARY

One or more example embodiments provide a timing controller that restores setting values to registers when switching from a power-down state to a power-up state, and a display device and system including the same.

One or more example embodiments provide a smaller-sized timing controller, and a display device and system including the same.

One or more example embodiments provide a timing controller with reduced power consumption, a display device and a system including the same.

According to an aspect of an example embodiment, a timing controller includes: a plurality of registers located in a power gating region and configured to store a plurality of setting values;
an image processing circuit configured to receive an image signal and perform image processing on the image signal based on the plurality of setting values;
a restore memory located outside the power gating region and configured to store the plurality of setting values; and
a bus controller configured to receive the plurality of setting values and store the plurality of setting values in the plurality of registers and the restore memory.

According to another aspect of an example embodiment, a display device includes: a pixel array including a plurality of pixels, a plurality of gate lines and a plurality of source lines respectively connected to the plurality of pixels; a driving circuit configured to transmit signals for driving the plurality of pixels to the plurality of source lines based on image data; and a timing controller configured to receive a plurality of setting values, store the plurality of setting values in a plurality of registers and a restore memory, receive an image signal, process the image signal based on the plurality of setting values stored in the plurality of registers to obtain a processed image signal, generate the image data based on the processed image signal, and provide the image data to the driving circuit.

According to another aspect of an example embodiment, a display system includes: a host device configured to output a plurality of addresses and a plurality of setting values corresponding to the plurality of addresses; and a display device configured to store the plurality of setting values in a plurality of registers indicated by the plurality of addresses, store the plurality of setting values in a restore memory based on a plurality of memory addresses corresponding to the plurality of addresses, and restore the plurality of setting values stored in the restore memory to the plurality of registers.

### BRIEF DESCRIPTION OF DRAWINGS

The above and other aspects and features will be more apparent from the following description of embodiments with reference to the attached drawings, in which:

FIG. 1 is an example block diagram of a display system according to an example embodiment;

FIG. 2 is a block diagram illustrating a timing controller according to an example embodiment;

FIG. 3 is a diagram illustrating a portion of a timing controller according to an example embodiment;

FIG. 4 is a diagram illustrating a bus controller, a bus-memory interface circuit, a register core, and a restore memory during data storing according to an example embodiment;

FIG. 5 is a diagram illustrating a bus controller, a bus-memory interface circuit, a register core, and a restore memory during data reading according to an example embodiment;

FIG. 6 is a diagram illustrating a bus controller, a restore control circuit, a register core, and a restore memory during data restoration according to an example embodiment;

FIG. 7 is a timing diagram illustrating a power gating operation of a display device according to an example embodiment;

FIG. 8 is a timing diagram illustrating the operation of a timing controller during power-up, according to an example embodiment;

FIG. 9 illustrates a display device according to an example embodiment;

FIG. 10 illustrates a register core according to an example embodiment;

FIG. 11 is a block diagram illustrating a selection signal generator according to an example embodiment;

FIG. 12 illustrates a register core according to an example embodiment; and

FIG. 13 illustrates a display system according to an example embodiment.

### DETAILED DESCRIPTION

Hereinafter, example embodiments are described in detail with reference to the accompanying drawings. Like components are denoted by like reference numerals throughout the specification, and repeated descriptions thereof are omitted. It will be understood that when an element or layer is referred to as being “on,” “connected to” or “coupled to” another element or layer, it can be directly on, connected or coupled to the other element or layer, or intervening elements or layers may be present. By contrast, when an element is referred to as being “directly on,” “directly connected to” or “directly coupled to” another element or layer, there are no intervening elements or layers present. Embodiments described herein are example embodiments, and thus, the present disclosure is not limited thereto, and may be realized in various other forms. Each example embodiment provided in the following description is not excluded from being associated with one or more features of another example or another example embodiment also provided herein or not provided herein but consistent with the present disclosure.

Accordingly, the drawings and description are to be regarded as illustrative in nature and not restrictive. In methods described with reference to drawings in this description, the operation order may be changed, several operations may be merged, certain operations may be divided, and specific operations may not be performed.

Singular expressions in this specification may be interpreted as the singular or plural unless an explicit expression such as “one” or “single” is used. Also, terms of “first,” “second,” and the like are used to explain various constituent elements, and the constituent elements are not limited to such terms. These terms are only used to distinguish one constituent element from another constituent element.

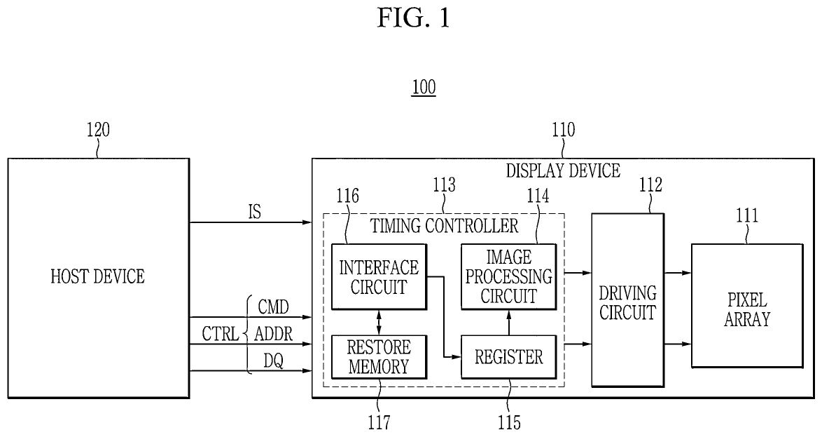

FIG. 1 is an example block diagram of a display system according to an example embodiment.

Referring to FIG. 1, a display system 100 may include a display device 110 and a host device 120.

The display device 110 may receive image data IS transmitted from the host device 120 and display an image according to the image data IS. The display device 110 may include a pixel array 111, a driving circuit 112, and a timing controller 113. In some example embodiments, the display device 110 may further include a power supply circuit such as a DC/DC converter that provides a driving voltage to the pixel array 111, the driving circuit 112, and the timing controller 113.

In an example embodiment, the pixel array 111 may display an image to the user according to image data IS received from the host device 120. The pixel array 111 may include a liquid crystal display (LCD), an organic light-emitting diode (OLED) display, an inorganic light emitting diode (ILED) display, a micro light emitting diode (μLED) display, an active matrix OLED display (AMOLED), and a transparent OLED (TOLED) display, etc. The pixel array 111 may include a plurality of pixels, a plurality of gate lines and a plurality of source lines respectively connected to the plurality of pixels. In an example embodiment, the plurality of pixels may emit light of a predominant color, such as red, green, blue, white, or yellow.

The driving circuit 112 may receive image data, control signals, etc., from the timing controller 113 and output a signal that drives the pixel array 111. A signal driving the pixel array 111 may be transmitted to a plurality of pixels through a plurality of gate lines and a plurality of source lines. In an example embodiment, the driving circuit 112 may generate gate signals and data signals that drive a plurality of pixels included in the pixel array 111, and provide gate signals and data signals to the plurality of pixels. A plurality of pixels included in the pixel array 111 may emit image light by a signal provided by the driving circuit 112.

The timing controller 113 may generate image data, control signals, etc., provided to the driving circuit 112 based on the image signal IS received from the host device 120. The timing controller 113 may receive the image signal IS, process the image signal IS based on pre-stored setting values, and generate image data based on the processed image signal IS. The timing controller 113 may generate a control signal for controlling the driving circuit 112 based on a driving control signal CTRL received from the outside and transmit the control signal and image data to the driving circuit 112. The driving control signal CTRL may include a horizontal synchronization signal Hsync, a vertical synchronization signal Vsync, a main clock signal MCLK, and a data enable signal DE.

The timing controller 113 may include an image processing circuit 114, a register 115, an interface circuit 116, and a restore memory 117.

The image processing circuit 114 may perform image processing on the image signal IS. For example, the image processing circuit 114 may compensate, scale, dim, color calibrate, or gamma calibrate the image signal IS. The image processing circuit 114 may generate image data based on the image processed image signal IS.

In some example embodiments, the image processing circuit 114 may read a setting value stored in the register 115 and perform image processing on the image signal IS based on the setting value. Because the image processing circuit 114 performs various image processing, various setting values corresponding to each image processing may be stored in the register 115.

The register 115 may store setting values received from the host device 120. The register 115 may receive a command CMD instructing writing, an address ADDR, and data DQ of the register 115 from the host device 120, and store the inputted value as data DQ in the region corresponding to the address ADDR.

In some example embodiments, at least a portion of the image processing circuit 114 and at least a portion of the register 115 may be power gated. During the power gating period, power supplied to at least a portion of the image processing circuit 114 and at least a portion of the register 115 may be interrupted.

Interface circuit 116 may interface with host device 120. In some example embodiments, when a command CMD instructing writing, an address ADDR, and data DQ are input from the host device 120, the interface circuit 116 may store data DQ in the register 115 indicated by the address ADDR. The interface circuit 116 may store the data DQ at the address of the restore memory 117 corresponding to the address ADDR.

In some example embodiments, the interface circuit 116 may store the setting value in the restore memory 117 and restore the setting value stored in the restore memory 117 to the register 115. The setting value stored in the register 115 whose power supply is interrupted during the power gating period may be lost or corrupted, and therefore cannot be used by the image processing circuit 114 after the power gating period ends. The interface circuit 116 may restore the setting value stored in the restore memory 117 to the register 115 after the power gating period ends. Then, the image processing circuit 114 may use the setting value restored in the register 115 even after the power gating period ends. The interface circuit 116 may store the setting value corresponding to each register 115 in the register 115 based on the address of the restore memory 117.

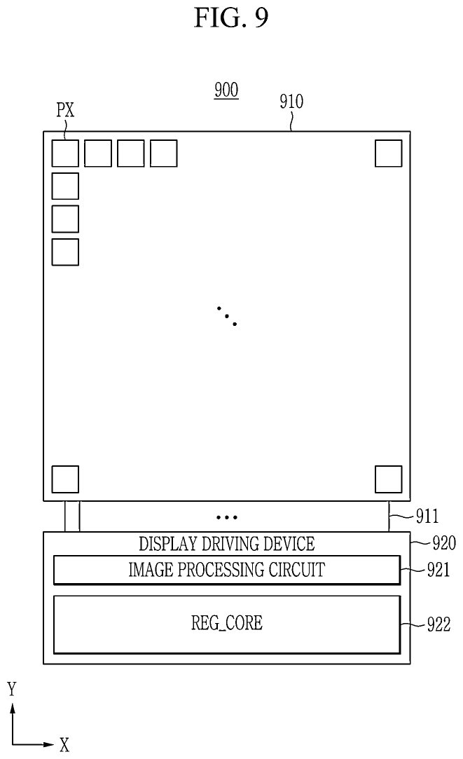

In some example embodiments, the interface circuit 116 may store the setting value in the restore memory 117, receive a command CMD instructing to read from the host device 120, read the setting value from the restore memory 117, and output the setting value to the host device 120. The interface circuit 116 may receive a read command CMD from the host device 120 and may not read the setting value stored in the register 115. Therefore, according to example embodiments, because wiring for reading the setting value from the register 115 is not required, area overhead may be reduced. This will be described later with reference to FIGS. 9 to 12.

The restore memory 117 may store setting values received from the host device 120. The restore memory 117 may be implemented as a volatile memory. The volatile memory may be implemented as random access memory (RAM), static RAM (SRAM), dynamic RAM (DRAM), synchronous DRAM (SDRAM), thyristor RAM (T-RAM), zero capacitor RAM (Z-RAM), or twin transistor RAM (TTRAM).

In some example embodiments, the interface circuit 116 and the restore memory 117 may not be power gated. During the power gating period, the setting value stored in the register 115 is volatilized, but the setting value stored in the restore memory 117 may be maintained.

The host device 120 may be a computing device or system that controls the display device 110 to display an image desired by the user on the pixel array 111 from the outside. The host device 120 may transmit image data IS according to content to be presented to the user to the display device 110. The host device 120 may provide the display device 110 with a driving control signal CTRL for controlling the display device 110. The drive control signal CTRL may include a command CMD, an address ADDR, and data DQ. Data DQ may include setting values for controlling the display device 110. In some example embodiments, the host device 120 may provide a command CMD such as sleep or awake to the display device 110. The host device 120 may provide a command CMD for writing a setting value to the register 150 to the display device 110. The host device 120 may provide a command CMD to read a setting value from the display device 110.

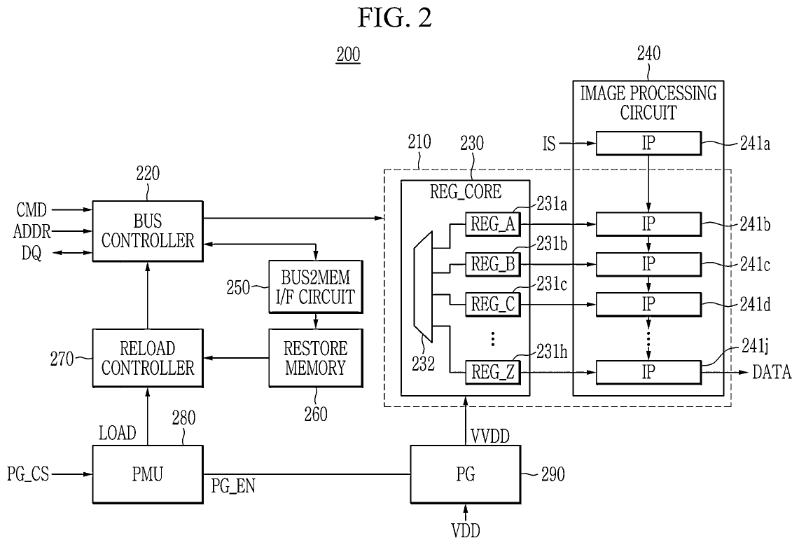

FIG. 2 is a block diagram illustrating a timing controller according to an example embodiment.

Referring to FIG. 2, a timing controller 200 may include a power gating region 210. During the power gating period, power provided to the power gating region 210 may be interrupted. Power gating may not refer to directly interrupting the power supplied to the power gating region 210, but may indicate turning off a power gating module 290 connecting the power gating region 210 and the power source.

The timing controller may include a bus controller 220, a register core 230, an image processing circuit 240, a bus-memory interface circuit 250, a restore memory 260, a reload controller 270, a power management unit (e.g., a power management circuit) 280, and a power gating module (e.g., a power gating module) 290.

The bus controller 220 may receive a command CMD, an address ADDR, and data DQ from the host device (120 in FIG. 1).

The bus controller 220 may receive a command CMD instructing writing, an address ADDR indicating registers 231a, 231b, 231c, . . . , 231h, and data DQ from the host device 120, and store data DQ in the register corresponding to the address ADDR among the registers 231a, 231b, 231c, . . . , 231h. The bus controller 220 may receive a command CMD instructing to read from the host device 120, and output the setting value stored in the restore memory 260 through the bus-memory interface circuit 250 to the host device 120 as data DQ.

The register core 230 may include a plurality of registers 231a, 231b, 231c, . . . , 231h and a multiplexer circuit 232 connected to the plurality of registers 231a, 231b, 231c, . . . , 231h. The plurality of registers 231a, 231b, 231c, . . . , 231h may store setting values used in the corresponding intellectual properties (IPs) 241b, 241c, 241d, . . . , 241j.

The multiplexer circuit 232 may select a register in which data DQ will be stored among the plurality of registers 231a, 231b, 231c, . . . , 231h, and provide data DQ provided from the bus controller 220 to the selected register.

The image processing circuit 240 may process the input image signal IS and generate image data DATA. The image processing circuit 240 may include the plurality of IPs 241a, 241b, 241c, 241d, . . . , 241j that process the image signal IS. Here, IP refers to a circuit, logic, or a combination thereof that may be included in the image processing circuit 240. The plurality of IPs 241a, 241b, 241c, 241d, . . . , 241j may independently process different multimedia processing tasks. Each of the plurality of IPs 241a, 241b, 241c, 241d, . . . , 241j may process the image signal IS sequentially or in parallel. In some example embodiments, the plurality of IPs 241b, 241c, 241d, . . . , 241j may perform image processing using setting values stored in the plurality of registers 231a, 231b, 231c, . . . , 231h. Each of the plurality of IPs 241b, 241c, 241d, . . . , 241j may read the setting values stored in the corresponding registers among the plurality of registers 231a, 231b, 231c, . . . , 231h and perform image processing according to the setting values.

The bus-memory interface circuit 250 may receive an address ADDR and data DQ from the bus controller 220, and control the restore memory 260 to store the data DQ in the region corresponding to the address ADDR of the restore memory 260. The bus-memory interface circuit 250 may receive an address ADDR from the bus controller 220, and control the restore memory 260 to output the setting value stored in the region corresponding to the address ADDR of the restore memory 260.

The restore memory 260 may store at least some of the plurality of setting values stored in the plurality of registers 231a, 231b, 231c, . . . , 231h. The restore memory 260 may include a plurality of regions corresponding to the plurality of addresses ADDR. Each of the plurality of regions may be previously associated with an address ADDR. The restore memory 260 may receive an address ADDR and data DQ, and store the data DQ in the region associated with the address ADDR. The restore memory 260 may receive the address ADDR and output data DQ stored in the region associated with the address ADDR.

The reload controller 270 may read the setting value stored in the restore memory 260 and output the setting value to the bus controller 220. In some example embodiments, the reload controller 270 may generate a restore address corresponding to the setting value. The reload controller 270 may receive a load signal LOAD from the power management unit 280 and generate a restore address based on the load signal LOAD. For example, the reload controller 270 may generate a restore address based on a value counted since receiving the load signal LOAD of enable level. The reload controller 270 may transmit the setting value and restore address to the bus controller 220. The bus controller 220 may transmit the setting value and restore address to the register core 230. The register core 230 may store the setting value in a register corresponding to the restore address among the registers 231a, 231b, 231c, . . . , 231h.

The power management unit 280 may perform power gating based on the characteristics and/or command CMD of the image signal IS. For example, the vertical blank period determined based on the image signal IS and/or the command CMD, and the power management unit 280 may perform power gating to interrupt power provided to the power gating region 210 during the vertical blank period. In some example embodiments, the power management unit 280 may receive a power gating control signal PG_CS that interrupts power provided to the power gating region, and output a power gating signal PG_EN that controls the operation of the power gating module 290. The power gating control signal PG_CS may be generated based on the image signal IS and/or command CMD. The power management unit 280 may generate the load signal LOAD based on the power gating control signal PG_CS and output the load signal LOAD to the reload controller 270.

The power gating module 290 may selectively provide power VVDD to circuits in the power gating region 210. The power gating module 290 may selectively provide power VVDD to the registers 231a, 231b, 231c, . . . , 231h, the multiplexer circuit 232, and the IPs 241b, 241c, 241d, . . . , 241j of the power gating region 210. The power gating module 290 may independently provide power VVDD to the registers 231a, 231b, 231c, . . . , 231h, the multiplexer circuit 232, and the IPs 241b, 241c, 241d, . . . , 241j within the power gating region 210. The power gating module 290 may selectively provide power VVDD to all circuits within the power gating region 210. The power gating module 290 may include a plurality of switch cells (e.g., switch circuits or transistors), each associated with a different one of the circuits in power gating region 210. The power gating module 290 may include a driver module or an intermediate software intelligence layer to independently control a plurality of switch cells for selectively connecting and disconnecting circuits in the power gating region 210 and a power source providing power VDD. The power gating module 290 may receive the power gating signal PG_EN at the enable level and interrupt the power VVDD provided to the power gating region 210. The power gating module 290 may receive the power gating signal PG_EN at a disable level and provide power VVDD to the power gating region 210.

The timing controller 200 receives a command CMD from the host device 120 to read the settings values stored in the plurality of registers 231a, 231b, 231c, . . . , 231h, and outputs the values stored in the restore memory 260 to the host device 120, so that additional wiring and multiplexers are not required to read the settings values stored in the plurality of registers 231a, 231b, 231c, . . . , 231h, thereby reducing the size of the chip. In addition, in the related art, a plurality of registers are configured as data retention flipflops so that the setting values stored in the plurality of registers are retained even when power gating is performed. In contrast, in the timing controller 200 according to example embodiments, when power gating ends, the setting values are restored to the plurality of registers 231a, 231b, 231c, . . . , 231h by the reload controller 270, thereby eliminated the need for the data retention flipflops, and reducing the chip size and power consumption.

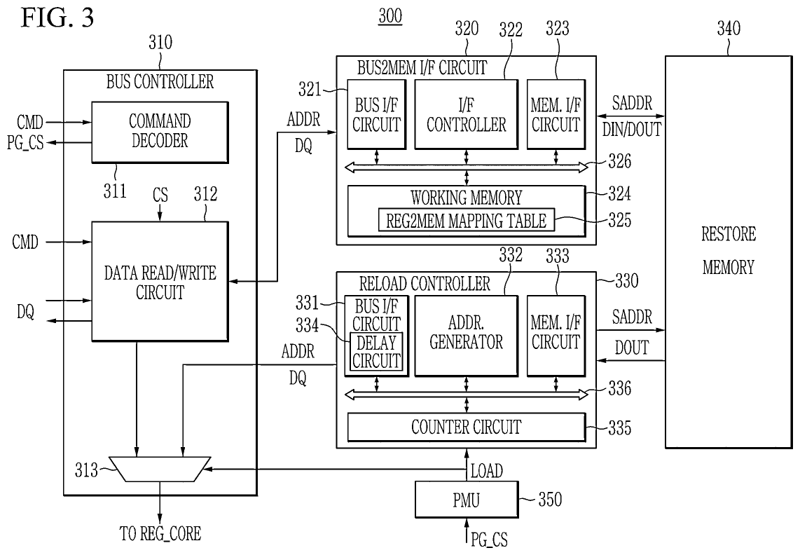

FIG. 3 is a diagram illustrating a portion of a timing controller according to an example embodiment.

Referring to FIG. 3, a timing controller 300 may include a bus controller 310, a bus-memory interface circuit 320, a reload controller 330, a restore memory 340, and a power management unit 350.

The bus controller 310 may receive a command CMD, an address ADDR, and data DQ from the host device (120 in FIG. 1). The bus controller 310 may receive a command CMD instructing writing, transmit the address ADDR and data DQ to a register core REG_CORE, and transmit the address ADDR and data DQ to the bus-memory interface circuit 320. The bus controller 310 may receive a command CMD instructing read and transmit an address ADDR to the bus-memory interface circuit 320. The bus controller 310 may receive data DQ from the bus-memory interface circuit 320. In some example embodiments, the bus controller 310 may receive an address ADDR and data DQ from the reload controller 330. The bus controller 310 may transmit the address ADDR and data DQ received from the reload controller 330 to the register core REG_CORE. The bus controller 310 may include a command decoder 311, a data read/write circuit 312, and a multiplexer circuit 313.

The command decoder 311 may receive a command CMD transmitted from the host device 120. The command decoder 311 may decode the received command CMD and generate a control signal CS and/or a power gating control signal PG_CS. The control signal CS may be provided to the data read/write circuit 312, and the power gating control signal PG_CS may be provided to the power management unit 350.

The data read/write circuit 312 may perform write and read operations based on the control signal CS. The data read/write circuit 312 may perform a write operation by transmitting the address ADDR and data DQ to the register core REG_CORE and the bus-memory interface circuit 320. The data read/write circuit 312 may perform a read operation by transmitting an address ADDR to the bus-memory interface circuit 320.

The multiplexer circuit 313 may output one of the address ADDR and data DQ output from the data read/write circuit 312, and the address ADDR and data DQ output from the reload controller 330. Based on the level of the load signal LOAD, the multiplexer circuit 313 may output one of the address ADDR and data DQ output from the data read/write circuit 312, and the address ADDR and data DQ output from the reload controller 330. For example, when the load signal LOAD is at an enable level, the multiplexer circuit 313 may output the address ADDR and data DQ output from the reload controller 330 to the register core REG_CORE. When the load signal LOAD is at a disable level, the multiplexer circuit 313 may output the address ADDR and data DQ output from the data read/write circuit 312 to the register core REG_CORE.

The bus-memory interface circuit 320 may receive an address ADDR and data DQ from the bus controller 310. The bus-memory interface circuit 320 may transmit input data DIN based on the memory address SADDR and data DQ corresponding to the address ADDR to the restore memory 340. The input data DIN may be stored in a memory address SADDR of the restore memory 340. The bus-memory interface circuit 320 may receive an address ADDR from the bus controller 310. The bus-memory interface circuit 320 may transmit the memory address SADDR corresponding to the address ADDR to the restore memory 340, and receive an output data DOUT stored in the memory address SADDR from the restore memory 340. The bus-memory interface circuit 320 may include a bus interface circuit 321, an interface controller 322, a memory interface circuit 323, a working memory 324, and a bus 326. The bus interface circuit 321, the interface controller 322, the memory interface circuit 323, and the working memory 324 may communicate with each other through the bus 326.

The bus interface circuit 321 may provide a physical connection between the bus controller 310 and the bus-memory interface circuit 320. That is, the bus interface circuit 321 may provide interfacing with the bus-memory interface circuit 320 according to the bus format of the bus controller 310.

The memory interface circuit 323 may communicate with the restore memory 340. The memory interface circuit 323 may transmit data to the restore memory 340 and receive data read from the restore memory 340. In an example embodiment, the memory interface circuit 323 may be connected to the restore memory 340 through one channel. In another example embodiment, the memory interface circuit 323 may be connected to the restore memory 340 through a plurality of channels.

The interface controller 322 may control the operation of the bus interface circuit 321 according to commands received through the bus controller 310. The interface controller 322 may receive an address ADDR and data DQ from the bus controller 310 through the bus interface circuit 321, and determine the memory address SADDR corresponding to the address ADDR based on the register-memory mapping table 325. The interface controller 322 may transmit the memory address SADDR and input data DIN to the restore memory 340 through the memory interface circuit 323 and store the input data DIN in the restore memory 340. The interface controller 322 may receive an address ADDR from the bus controller 310 through the bus interface circuit 321, and determine the memory address SADDR corresponding to the address ADDR based on the register-memory mapping table 325. The interface controller 322 may read the output data DOUT by transmitting the memory address SADDR to the restore memory 340 through the memory interface circuit 323.

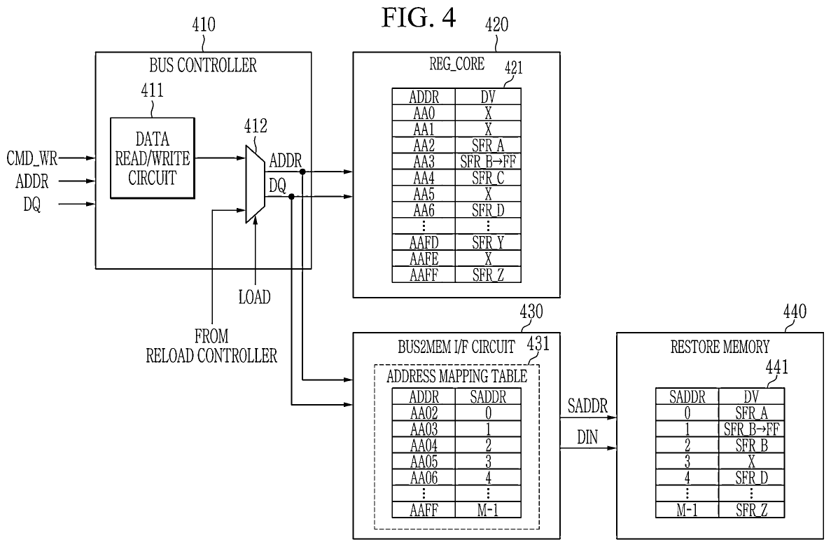

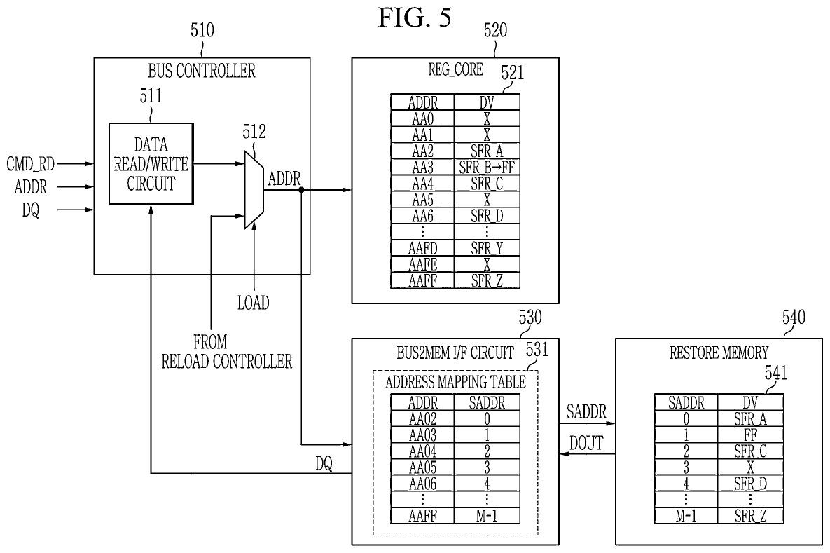

The working memory 324 may store instructions and data that are executed and processed by the interface controller 322. The working memory 324 may also be implemented as volatile memory such as DRAM or static RAM (SRAM), or non-volatile memory such as PRAM or flash memory. The working memory 324 may store the register-memory mapping table 325. The register-memory mapping table 325 will be described later with reference to FIGS. 4 and 5.

The reload controller 330 may receive the load signal LOAD from the power management unit 350. The reload controller 330 may receive the load signal LOAD at an enable level and generate an address ADDR and a memory address SADDR. The reload controller 330 may transmit a memory address SADDR to the restore memory 340 and receive the output data DOUT output from the restore memory 340. The reload controller 330 may output the output data DOUT as data DQ to the bus controller 310. The reload controller 330 may output data DQ and address ADDR together. The reload controller 330 may include a bus interface circuit 331, an address generator 332, a memory interface circuit 333, a counter circuit 335, and a bus 336. The bus interface circuit 331, the address generator 332, the memory interface circuit 333, and the counter circuit 335 may communicate with each other via the bus 336.

The bus interface circuit 331 may provide a physical connection between the reload controller 330 and the bus controller 310. That is, the bus interface circuit 331 may provide interfacing with the bus controller 310 according to the bus format of the reload controller 330. The bus interface circuit 331 may include a delay circuit 334. The delay circuit 334 may delay the address ADDR to be output to the bus controller 310, and output the address ADDR together with the data DQ.

The memory interface circuit 333 may communicate with the restore memory 340. The memory interface circuit 333 may transmit data to the restore memory 340. The memory interface circuit 333 may output a memory address SADDR to the restore memory 340 and receive data read from the memory address SADDR of the restore memory 340. In an example embodiment, the memory interface circuit 333 may be connected to the restore memory 340 through one channel. In another example embodiment, the memory interface circuit 333 may be connected to the restore memory 340 through a plurality of channels.

The counter circuit 335 may count the clock signal (e.g., a rising edge or a falling edge), and may start counting when the load signal LOAD at the enable level is received. The counter circuit 335 may output the counted value to the address generator 332.

The address generator 332 may generate an address ADDR and a memory address SADDR based on the value output by the counter circuit 335. The address generator 332 may output a memory address SADDR to the memory interface circuit 333 and output an address ADDR to the delay circuit 334.

The power management unit 350 may receive the power gating control signal PG_CS. The power management unit 350 may have any one of a power gating state, an idle state, and a reload state. When the power management unit 350 receives the power gating control signal PG_CS at an enable level, the power management unit 350 may be changed to the power gating state.

When the power gating control signal PG_CS transitions from the enable level to the disable level, the power management unit 350 changes the power gating state to the reload state and may maintain the reload state for a predetermined period of time. The power management unit 350 may output the load signal LOAD at an enable level in the reload state. The power management unit 350 may change to an idle state after a predetermined period of time has elapsed. The power management unit 350 may output the load signal LOAD to the multiplexer circuit 313 and the counter circuit 335.

FIG. 4 is a diagram illustrating a bus controller, a bus-memory interface circuit, a register core, and a restore memory during data storing according to an example embodiment.

Referring to FIG. 4, the bus controller 410 may receive a write command CMD_WR, an address ADDR, and data DQ. The bus controller 410 may output an address ADDR and data DQ to a register core 420 and a bus-memory interface circuit 430. The bus controller 410 may include a data read/write circuit 411 and a multiplexer circuit 412.

The data read/write circuit 411 may output an address ADDR and data DQ to the multiplexer circuit 412 based on the write command CMD_WR received from the host device (120 in FIG. 1). The multiplexer circuit 412 may output the address ADDR and data DQ transmitted from the data read/write circuit 411 based on the level of the load signal LOAD. For example, when the load signal LOAD is at a disable level, the multiplexer circuit 412 may output the address ADDR and data DQ transmitted from the data read/write circuit 411 to the register core 420 and bus-memory interface circuit 430. For example, when the load signal LOAD is at an enable level, the multiplexer circuit 412 may output the data DQ and the address ADDR output from the reload controller to the register core 420 and the bus-memory interface circuit 430.

The register core 420 may include a plurality of registers 421 corresponding to a plurality of addresses AA0, . . . , AAFF. Each of the plurality of registers may store data DV. For example, the register corresponding to address AA2 may store a setting value SFR_A. The register core 420 may store data DQ in a register corresponding to the address ADDR based on the address ADDR and data DQ input from the bus controller 410. For example, if the address ADDR input to the register core 420 is “AA3” and the input data DQ is “FF”, the register core 420 may store “FF” in the register corresponding to the address ADDR “AA3”.

The bus-memory interface circuit 430 may determine a memory address SADDR corresponding to the address ADDR based on the address ADDR input from the bus controller 410. The bus-memory interface circuit 430 may include an address mapping table 431 in which addresses ADDR and memory address SADDR are mapped. The bus-memory interface circuit 430 may determine the memory address SADDR corresponding to the input address ADDR based on the address mapping table 431. The bus-memory interface circuit 430 may provide the determined memory address SADDR and input data DIN to a restore memory 440. Here, the input data DIN may include data DQ input from the bus controller 410. For example, if the address ADDR input to the bus-memory interface circuit 430 is “AA3” and the input data DQ is “FF”, the bus-memory interface circuit 430 may output the memory address SADDR “1” corresponding to the “AA3” and input data DIN “FF”.

The restore memory 440 may receive a memory address SADDR and input data DIN from the bus-memory interface circuit 430. The restore memory 440 may include a plurality of storage regions 441 corresponding to a memory address SADDR. The restore memory 440 may store the input data DIN in the region corresponding to the memory address SADDR received from the bus-memory interface circuit 430. For example, if the memory address SADDR input to the restore memory 440 is “1” and the input data DIN is “FF”, the restore memory 440 may store data DV “FF” in the corresponding region.

According to example embodiments, data DQ input from the host device 120 may be written to both the register core 420 and the restore memory 440. According to example embodiments, when a command CMD_RD to read data DV stored in the register 421 of the register core is received from the host device 120, the data DV stored in the restore memory 440 may be output to the host device 120.

FIG. 5 is a diagram illustrating a bus controller, a bus-memory interface circuit, a register core, and a restore memory during data reading according to an example embodiment.

Referring to FIG. 5, the bus controller 510 may receive a read command CMD_RD and an address ADDR. The bus controller 510 may output an address ADDR to a bus-memory interface circuit 530. The bus controller 510 may include a data read/write circuit 511 and a multiplexer circuit 512.

The data read/write circuit 511 may output an address ADDR to the multiplexer circuit 512 based on the read command CMD_RD received from the host device (120 in FIG. 1). The multiplexer circuit 512 may output the address ADDR transmitted from the data read/write circuit 511 based on the level of the load signal LOAD. For example, when the load signal LOAD is at a disable level, the multiplexer circuit 512 may output the address ADDR transmitted from the data read/write circuit 511 to the register core 520 and the bus-memory interface circuit 530.

Even if the address ADDR is input from the bus controller 510, the register core 520 may not output data DV from the register corresponding to the address ADDR.

In some example embodiments, the bus controller 510 may not output the address ADDR to the register core 520 when the read command CMD_RD is received.

The bus-memory interface circuit 530 may determine a memory address SADDR corresponding to the address ADDR based on the address ADDR input from the bus controller 510. The bus-memory interface circuit 530 may provide the determined memory address SADDR to the restore memory 540. For example, if the address ADDR input to the bus-memory interface circuit 530 is “AA3”, the bus-memory interface circuit 530 may output the memory address SADDR “1” corresponding to “AA3”.

The restore memory 540 may receive a memory address SADDR from the bus-memory interface circuit 530. The restore memory 540 may output the value DV stored in the region corresponding to the memory address SADDR received from the bus-memory interface circuit 530. For example, if the memory address SADDR input to the restore memory 540 is “1”, the restore memory 540 may output the data DV “FF” stored in the region corresponding to “1” as output data DOUT.

The bus-memory interface circuit 530 may transmit output data DOUT output from the restore memory 540 to the bus controller 510 as data DQ. Then, the bus controller 510 may output data DQ to the host device 120.

According to example embodiments, when a command CMD_RD to read data DV stored in the register 521 of the register core is received from the host device 120, the data DV stored in the restore memory 540 may be output to the host device 120.

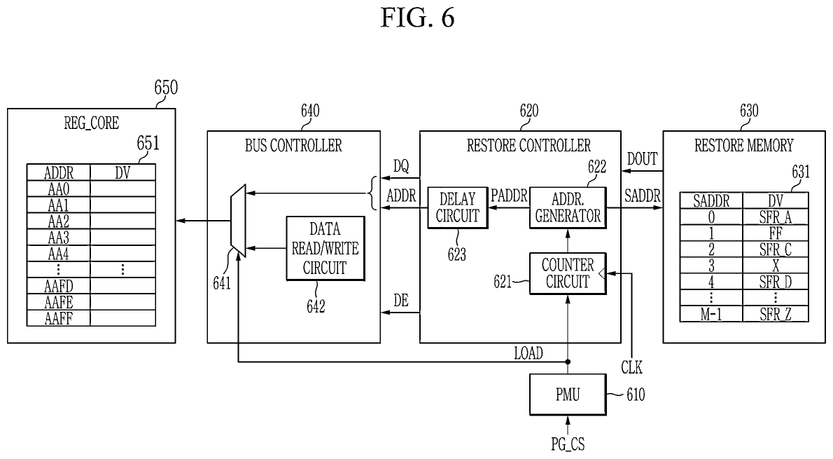

FIG. 6 is a diagram illustrating a bus controller, a restore control circuit, a register core, and a restore memory during data restoration according to an example embodiment.

Referring to FIG. 6, a power management unit 610 may receive a power gating control signal PG_CS. When the power gating control signal PG_CS transitions from the enable level to the disable level, the power management unit 610 may output the load signal LOAD at the enable level. For example, the power management unit 610 may output the load signal LOAD at the enable level for a predetermined period of time from when the power gating control signal PG_CS transitions from the enable level to the disable level. The power management unit 610 may output a load signal LOAD to the multiplexer 641 and the counter circuit 621.

A restore controller 620 may receive a load signal LOAD at an enable level and generate a memory address SADDR and a restore address PADDR. The restore controller 620 may include a counter circuit 621, an address generator 622, and a delay circuit 623.

The counter circuit 621 may receive a load signal LOAD and a clock signal CLK. The counter circuit 621 may count the clock signal CLK when the load signal LOAD is at an enable level. The counter circuit 621 may output a counting value LOAD_CNT to the address generator 622.

The address generator 622 may generate a memory address SADDR and a restore address PADDR based on the counting value LOAD_CNT. The memory address SADDR and restore address PADDR corresponding to the counting value LOAD_CNT may be set in advance. The address generator 622 may output a memory address SADDR to the restore memory 630. The address generator 622 may output the restore address PADDR to the delay circuit 623. The restore address PADDR may include the address of a register 651.

The delay circuit 623 may receive a restore address PADDR, delay the restore address PADDR, and output the restore address PADDR as an address ADDR. The address ADDR may be output to a bus controller 640 along with the output data DOUT transmitted from the restore memory 630 by the delay circuit 623. While reading the output data DOUT from the restore memory 630, the restore address PADDR may be delayed by the delay circuit 623.

The restore memory 630 may receive a memory address SADDR and output the value DV stored in the memory address SADDR as output data DOUT.

The bus controller 640 may receive data DQ and address ADDR output from the restore controller 620. A multiplexer circuit 642 may output the data DQ and the address ADDR output from the restore controller 620 based on the level of the load signal LOAD. For example, when the load signal LOAD is at an enable level, the multiplexer circuit 642 may output the data DQ and the address ADDR output from the restore controller 620 to the register core 650.

The register core 650 may store data DQ in a register corresponding to the address ADDR based on the address ADDR and data DQ input from the bus controller 640.

Because the power provided to the register 651 is interrupted during the power gating period, data stored in the register 651 may not be maintained. According to example embodiments, when the power gating period ends, data stored in the restore memory 630 may be restored to the register 651. Accordingly, because the register core 650 does not include a data retention flipflop for retaining data during the power gating period, the size and power consumption of the register core 650 may be reduced.

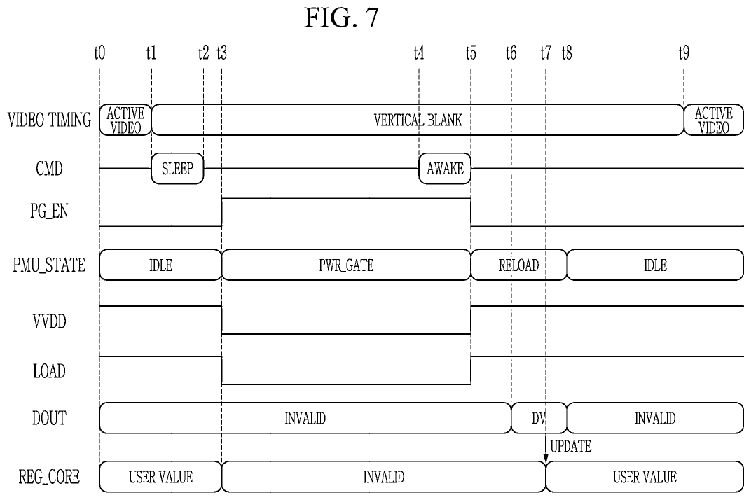

FIG. 7 is a timing diagram illustrating a power gating operation of a display device according to an example embodiment.

Referring to FIG. 7, video data may be activated at time t0. At this time, a state of the power management unit PMU_STATE is an idle state IDLE and may output a power gating signal PG_EN at a disable level. Because the power gating signal PG_EN is at a disable level, power VVDD may be provided to the register core REG_CORE. A user value USER VALUE stored in the register core REG_CORE may be maintained.

At time t1, a sleep command SLEEP may be input, and a vertical blank period VERTICAL BLANK may begin. At time t2, input of the sleep command SLEEP may be completed.

After the sleep command SLEEP is input, at time t3, the state of the power management unit PMU_STATE may change from the idle state IDLE to a power gating state PWR_GATE. The power management unit may output a power gating signal PG_EN at an enable level. Because the power gating signal PG_EN is at an enable level, the power VVDD provided to the register core REG_CORE may be interrupted. The user value USER VALUE stored in the register core REG_CORE may change to an invalid state INVALID.

An awake command AWAKE may be input at time t4. The awake command AWAKE is input, and at time t5, the state of the power management unit PMU_STATE may change from the power gating state PWR_GATE to the reload state RELOAD. The state of the power management unit PMU_STATE may output a power gating signal PG_EN at a disable level. Because the power gating signal PG_EN is at a disable level, power VVDD may be provided to the register core REG_CORE. Because the power gating signal PG_EN is changed from the enable level to the disable level, the load signal LOAD may change to the enable level.

At time t6, the value DV stored in the restore memory may be output as output data DOUT from the restore memory by the load signal LOAD at the enable level.

At time t7, output data DOUT may be updated in the register core REG_CORE. The user value USER VALUE may be restored to the register core REG_CORE.

At time t8, the state of the power management unit PMU_STATE may change from the reload state RELOAD to the idle state IDLE. At time t9, video data may be activated ACTIVE VIDEO again.

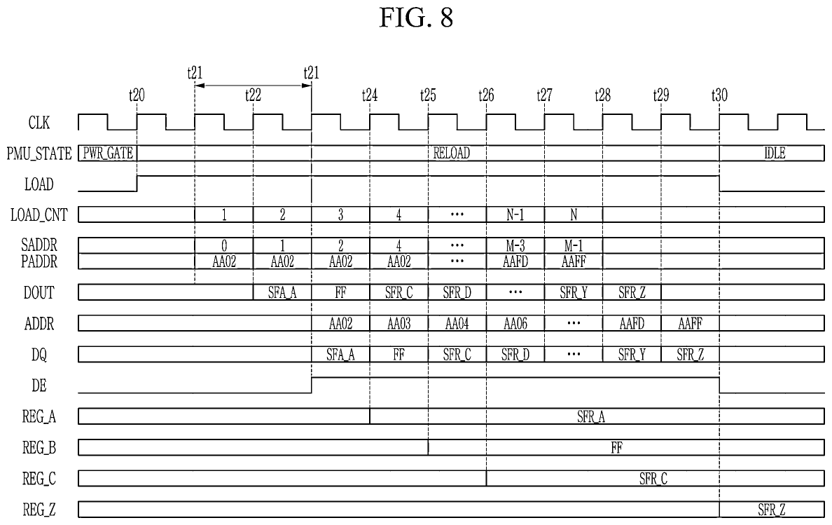

FIG. 8 is a timing diagram illustrating an operation during power-up of a display driving device according to an example embodiment.

Referring to FIG. 8, at time t20, the state of the power management unit PMU_STATE may change from the power gating state PWR_GATE to the reload state RELOAD. Accordingly, the load signal LOAD may change to the enable level.

When the load signal LOAD is at an enable level (period t21 to t30), the counting value LOAD_CNT may be output by counting the rising edges of the clock signal CLK. A memory address SADDR and a restore address PADDR may be generated based on the counting value LOAD_CNT. Output data DOUT “SFR_A” may be output at time t22 by the memory address SADDR “0” generated at time t21 and output to the restore memory.

The restore address PADDR may be delayed for a delay period DELAY PERIOD from time t21 and output to the register core as an address ADDR at time t23, and output data DOUT may be output to the register core as data DQ.

At time t24, data DQ “SFR_A” may be stored in a register REG_A of the register core. Likewise, from t25 to t30, data DQ may be stored in each register of the register core.

FIG. 9 illustrates a display device according to an example embodiment.

Referring to FIG. 9, a display device 900 may include a pixel array 910 including a plurality of pixels PX and a display driving device 920. The display driving device 920 may be connected to the pixel array 910. The display driving device 920 may output a signal for driving the pixel PX to the pixel array 910.

The display driving device 920 may include an image processing circuit 921 and a register core 922. The image processing circuit 921 may perform image processing on the input image signal based on the setting value stored in the register core 922. The display driving device 920 may have a length along the X-axis and a width along the Y-axis.

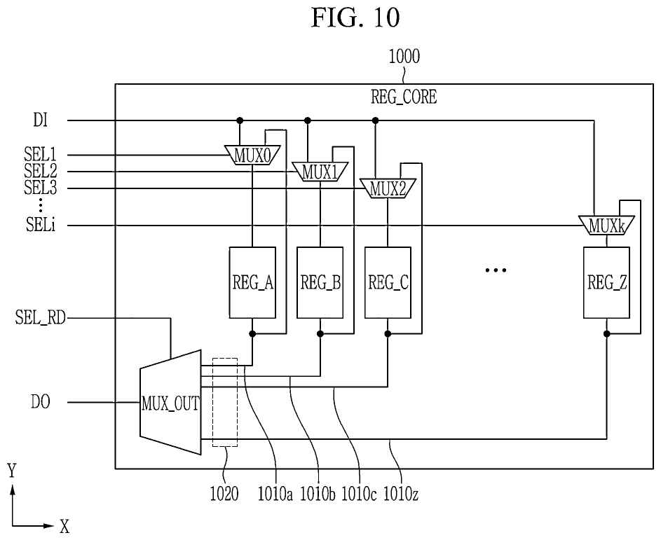

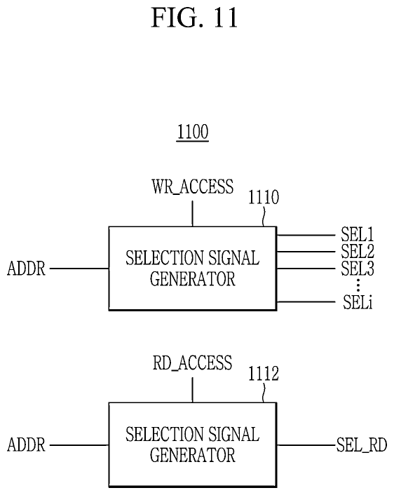

FIG. 10 illustrates a register core according to an example embodiment, and FIG. 11 is a block diagram illustrating a selection signal generator according to an example embodiment.

Referring to FIG. 10, a register core 1000 may receive input data DI and a plurality of selection signals SEL1, . . . , SELi, and store the input data DI in each of a plurality of registers REG_A, REG_B, REG_C, . . . , REG_Z based on the plurality of selection signals SEL1, . . . , SELi. The register core 1000 may receive a read select signal SEL_RD, and selectively output data stored in the plurality of registers REG_A, REG_B, REG_C, . . . , REG_Z as output data DO based on a read selection signal SEL_RD.

The register core 1000 may include the plurality of registers REG_A, REG_B, REG_C, . . . , REG_Z, a plurality of input multiplexer circuits MUX0, MUX1, MUX2, . . . , MUXk, and an output multiplexer circuit MUX_OUT. Although FIG. 10 shows the plurality of registers REG_A, REG_B, REG_C, . . . , REG_Z and the plurality of input multiplexer circuits MUX0, MUX1, MUX2, . . . , MUXk connected to one output multiplexer circuit MUX_OUT, the register core 1000 may include a plurality of register core groups MUX_OUT, REG_A, REG_B, REG_C, . . . , REG_Z, MUX0, MUX1, MUX2, . . . , MUXk of FIG. 10.

Referring to FIGS. 10 and 11 together, a register core 1100 may include selection signal generators 1110 and 1112. The selection signal generator 1110 may receive a write control signal WR_ACCESS and an address ADDR from the bus controller (310 in FIG. 3), and output the plurality of selection signal SEL1, . . . , SELi that selects one of the plurality of input multiplexer circuits MUX0, MUX1, MUX2), . . . , MUXk.

The selection signal generator 1112 may receive a read control signal RD_ACCESS and an address ADDR from the bus controller 310, and output a selection signal SEL_RD that selects one of the data input to the plurality of output multiplexer circuits MUX_OUT, based on the address ADDR.

The plurality of input multiplexer circuits MUX0, MUX1, MUX2, . . . , MUXk may be connected to the plurality of registers REG_A, REG_B, REG_C, . . . , REG_Z. The plurality of input multiplexer circuits MUX0, MUX1, MUX2, . . . , MUXk may select input data DI and one of the outputs of the plurality of registers REG_A, REG_B, REG_C, . . . , REG_Z based on the plurality of selection signals SEL1, . . . , SELi and output to the plurality of registers REG_A, REG_B, REG_C, . . . , REG_Z.

The output multiplexer circuit MUX_OUT may be connected to the plurality of registers REG_A, REG_B, REG_C, . . . , REG_Z through a plurality of wirings 1010a, 1010b, 1010c, . . . , 1010z. The output multiplexer circuit MUX_OUT may output data output from the plurality of registers REG_A, REG_B, REG_C, . . . , REG_Z as output data DO based on the read selection signal SEL_RD.

Because the plurality of wirings 1010a, 1010b, 1010c, . . . , 1010z are connected to an input terminal 1020 of the output multiplexer circuit MUX_OUT, the overall size of the display driving device may be increased by the length in the X-axis direction and the width in the Y-axis direction occupied by the plurality of the wirings 1010a, 1010b, 1010c, . . . , 1010z.

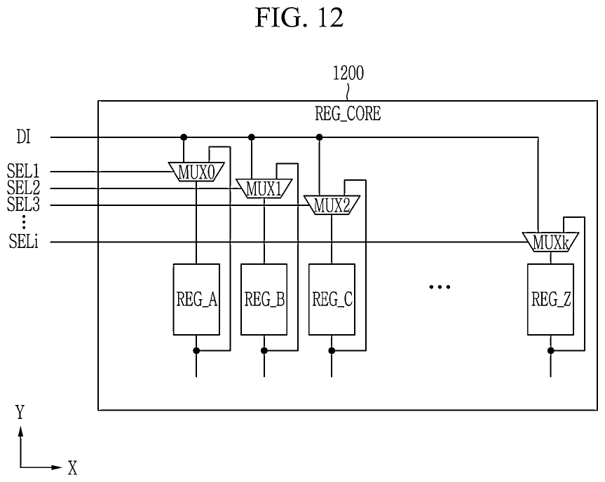

FIG. 12 illustrates a register core according to an example embodiment.

Referring to FIG. 12, a register core 1200 may receive input data DI and a plurality of selection signals SEL1, . . . , SELi, and store the input data DI in each of a plurality of registers REG_A, REG_B, REG_C, . . . , REG_Z based on the plurality of selection signals SEL1, . . . , SELi. The register core 1200 may include the plurality of registers REG_A, REG_B, REG_C, . . . , REG_Z and the plurality of input multiplexer circuits MUX0, MUX1, MUX2, . . . , MUXk.

Although FIG. 12 shows the plurality of registers REG_A, REG_B, REG_C, . . . , REG_Z and the plurality of input multiplexer circuits MUX0, MUX1, MUX2, . . . , MUXk, the register core 1000 may include a plurality of register core groups MUX_OUT, REG_A, REG_B, REG_C, . . . , REG_Z, MUX0, MUX1, MUX2, . . . , MUXk of FIG. 12.

The plurality of input multiplexer circuits MUX0, MUX1, MUX2, . . . , MUXk may be connected to the plurality of registers REG_A, REG_B, REG_C, . . . , REG_Z. The plurality of input multiplexer circuits MUX0, MUX1, MUX2, . . . , MUXk may select input data DI and one of the outputs of the plurality of registers REG_A, REG_B, REG_C, . . . , REG_Z based on the plurality of selection signals SEL1, . . . , SELi and output to the plurality of registers REG_A, REG_B, REG_C, . . . , REG_Z.

The display driving device according to example embodiments may not include an output multiplexer circuit, and a plurality of wirings connecting the output multiplexer circuit and the plurality of registers REG_A, REG_B, REG_C, . . . , REG_Z. Therefore, compared to the display driving device of FIG. 10, the size of the display driving device is smaller because the display driving device does not include the area due to the length in the X-axis direction and the width in the Y-axis direction occupied by the plurality of wirings.

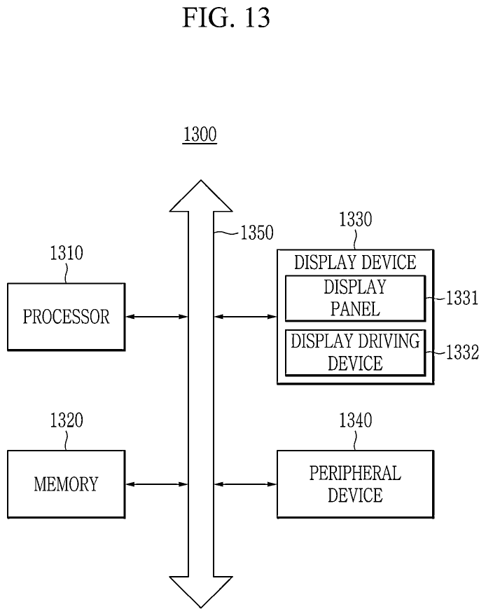

FIG. 13 illustrates a display system according to an example embodiment.

Referring to FIG. 13, a display system 1300 according to an example embodiment may include a processor 1310, a memory 1320, a display device 1330, and a peripheral device 1340 that are electrically connected to a system bus 1350.

The processor 1310 controls the input and output of data from the memory 1320, the display device 1330, and the peripheral device 1340, and may perform image processing of image data transmitted between the corresponding devices.

The memory 1320 may include volatile memory such as dynamic random-access memory (DRAM) and/or non-volatile memory such as flash memory. The memory 1320 may include DRAM, phase-change random access memory (PRAM), magnetic random-access memory (MRAM), resistive random-access memory (ReRAM), ferroelectric random-access memory (FRAM), NOR flash memory, NAND flash memory, and fusion flash memory (for example, memory combined with static random-access memory (SRAM) buffer and NAND flash memory and NOR interface logic). The memory 1320 may store image data obtained from the peripheral device 1340 or image signals processed by the processor 1310.

The display device 1330 may include a display panel 1331 and a display driving device 1332. The display driving device 1332 may include the timing controller described in FIGS. 1 to 12. The display driving device 1332 may display an image signal applied through the system bus 1350 on the display panel 1331. The display driving device 1332 may include a power gating region where an image processing circuit that processes image signals and where a register that stores setting values used in the image processing circuit are located. The display driving device 1332 may further include a restore memory that stores a setting value when the power gating region is in a power gating state. When the power gating state of the power gating region ends, the display driving device 1332 may restore the setting value to the register using the setting value stored in the restore memory.

The peripheral device 1340 may be a device that converts motion pictures, such as a camera, scanner or webcam, or still images into electrical signals. Image data obtained through the peripheral device 1340 may be stored in the memory 1320 or displayed on the display panel 1331 in real time.

The display system 1300 may be implemented in mobile electronic products such as smartphones, but is not limited thereto, and may be implemented in various types of electronic products that display images.

In some example embodiments, each constituent element or combination of two or more constituent elements described with reference to FIGS. 1 to 12 may be implemented by a digital circuit, a programmable or non-programmable logic device or array, or an application specific integrated circuit (ASIC), and the like.

While aspects of example embodiments have been particularly shown and described, it will be understood that various changes in form and details may be made therein without departing from the spirit and scope of the following claims.

What is claimed is:

1. A timing controller, comprising:
a plurality of registers located in a power gating region and configured to store a plurality of setting values;
an image processing circuit configured to receive an image signal and perform image processing on the image signal based on the plurality of setting values;
a restore memory located outside the power gating region and configured to store the plurality of setting values; and
a bus controller configured to receive the plurality of setting values and store the plurality of setting values in the plurality of registers and the restore memory.

2. The timing controller of claim 1, wherein the bus controller is further configured to receive a read command and an address indicating one of the plurality of registers, and output a setting value read based on a memory address corresponding to the address of the restore memory to the outside.

3. The timing controller of claim 2, further comprising a bus-memory interface circuit configured to receive the address from the bus controller, store a mapping table in which the address and the memory address are mapped, and transmit the setting value read from the restore memory based on the memory address to the bus controller.

4. The timing controller of claim 1, further comprising:
a power gating circuit configured to selectively provide power from a power source to the power gating region; and
a power management circuit configured to output a power gating signal to control the power gating circuit at an enable level during a power gating period to control the power gating circuit to not provide the power to the power gating region during the power gating period.

5. The timing controller of claim 4, further comprising a reload controller configured to read the plurality of setting values stored in the restore memory and store the plurality of setting values in the plurality of registers at an end of the power gating period.

6. The timing controller of claim 5, wherein the power management circuit is further configured to output a load signal at the enable level at the end of the power gating period, and
wherein the bus controller is further configured to receive the plurality of setting values read by the reload controller, and store the plurality of setting values in the plurality of registers while the load signal is at the enable level.

7. The timing controller of claim 6, wherein the reload controller comprises:
a counter circuit configured to count a clock signal based on the load signal being at the enable level;
an address generator configured to generate an address indicating one of the plurality of registers and a memory address corresponding to the address based on a value output by the counter circuit;
a memory interface circuit configured to output the memory address to the restore memory and receive data stored in the memory address; and
a delay circuit configured to delay the address so that the address is output together with the data.

8. The timing controller of claim 1, wherein the image processing circuit comprises a plurality of processing circuits configured to process the image signal using the plurality of setting values.

9. The timing controller of claim 8, wherein at least one of the plurality of processing circuits is located in the power gating region.

10. The timing controller of claim 1, further comprising a plurality of input multiplexer circuits comprising a first input multiplexer circuit and a second input multiplexer circuit,
wherein the plurality of registers comprises a first register and a second register,
wherein the first register is connected between an input and an output of the first input multiplexer circuit,
wherein the second register is connected between an input and an output of the second input multiplexer circuit, and
wherein the plurality of input multiplexer circuits are configured to output one of the plurality of setting values based on a plurality of selection signals.

11. The timing controller of claim 10, further comprising a selection signal generator configured to receive a plurality of addresses corresponding to the plurality of registers and generate the plurality of selection signals based on the plurality of addresses.

12. A display device, comprising:
a pixel array comprising a plurality of pixels, a plurality of gate lines and a plurality of source lines respectively connected to the plurality of pixels;
a driving circuit configured to transmit signals for driving the plurality of pixels to the plurality of source lines based on image data; and
a timing controller configured to receive a plurality of setting values, store the plurality of setting values in a plurality of registers and a restore memory, receive an image signal, process the image signal based on the plurality of setting values stored in the plurality of registers to obtain a processed image signal, generate the image data based on the processed image signal, and provide the image data to the driving circuit.

13. The display device of claim 12, wherein the plurality of registers are power-gated during a power gating period.

14. The display device of claim 13, wherein the timing controller is further configured to restore a plurality of stored setting values stored in the restore memory to the plurality of registers at an end of the power gating period.

15. The display device of claim 14, wherein the timing controller is further configured to process the image signal based on the plurality of setting values restored to the plurality of registers at the end of the power gating period.

16. The display device of claim 12, wherein the timing controller is further configured to receive a command for reading the plurality of setting values and output the plurality of setting values stored in the restore memory.

17. The display device of claim 16, wherein the timing controller is further configured to receive the command and an address indicating one of the plurality of registers, determine a memory address corresponding to the address, and output setting values, among the plurality of setting values, stored in a region of the restore memory corresponding to the memory address.

18. A display system, comprising:
a host device configured to output a plurality of addresses and a plurality of setting values corresponding to the plurality of addresses; and
a display device configured to store the plurality of setting values in a plurality of registers indicated by the plurality of addresses, store the plurality of setting values in a restore memory based on a plurality of memory addresses corresponding to the plurality of addresses, and restore the plurality of setting values stored in the restore memory to the plurality of registers.

19. The display system of claim 18, wherein the display device is further configured to restore the plurality of setting values stored in the restore memory to the plurality of registers at an end of a power gating period.

20. The display system of claim 18, wherein the host device is further configured to output at least one of the plurality of addresses and a read command, and
wherein the display device is further configured to output at least one setting value among the plurality of setting values from the restore memory to the host device based on the at least one of the plurality of addresses.
